(19) United States
(12) Patent Application Publication
(10) Pub. No.: US 2012/0295015 A1
(43) Pub. Date: Nov. 22, 2012

(54) METHOD FOR PREPARING ELECTRONIC COMPONENT-MOUNTING DEVICE

(75) Inventor: Chung-Yen YANG, New Taipei City (TW)

(73) Assignee: JIENG TAI INTERNATIONAL ELECTRIC CORP., New Taipei City (TW)

(21) Appl. No.: 13/471,108

(22) Filed: May 14, 2012

(30) Foreign Application Priority Data
May 16, 2011 (TW) 100117078

(51) Int. Cl. B05D 5/12

(52) U.S. Cl. 427/58

(57) ABSTRACT

A method for making an electronic component-mounting device. The electronic component-mounting device includes an antenna having a coating layer and a conductive layer that is mounted on a polymeric device body. The coating layer is formed on the surface of the polymeric device body with the conductive layer formed on the coating layer opposite the polymeric device body.

### CROSS REFERENCE TO RELATED APPLICATION

This application claims priority to Taiwan Application No. 100117078, filed May 16, 2011, the disclosure of which is herein incorporated by reference in its entirety.

### BACKGROUND OF THE INVENTION

1. Field of the Invention

The present invention relates to method for preparing an electronic component-mounting device having an antenna. In particular, this invention relates to a method for preparing an electronic component-mounting device that includes forming an antenna having a coating layer and an electrically conductive layer mounted on a polymeric device body.

2. Description of the Related Art

Currently, flexible printed circuit boards (FPCBs) are usually used as antennas in mobile electronic devices, such as smart phones. However, detachment occur when the FPCB is adhered to a non-planar surface (i.e., a three-dimensional structure). Advanced manufacturing technologies using Laser Direct Structuring (LDS) have prevailed when constructing such antennas on non-planar surfaces. First, in LDS technology, a LDS-grade material is injection molded to form a device body. The device body is then subjected to laser activation, whereby the surface of the substrate is activated by the laser beam. A rough surface with metallic nuclei is thereby created, in which the metallic nuclei act as a catalyst to facilitate metal plating during metallization. After metallization, a 5 to 8 μm width of the resultant circuit tracks is used as an antenna for receiving and transmitting RF signals.

Advantages provided by LDS include direct formation of an antenna made of alloys or metals on the device body. Direct construction of circuit tracks (antenna) on the device body allows miniaturization of electrical components to achieve the small size requirements of the electronic device. However, there are several problems: a complicated manufacturing procedure, high manufacturing cost, requirement of special materials and limited suppliers. Therefore, there is a need in the art to provide a simple method for forming an antenna on modern electronic devices with three dimensional structure.

### SUMMARY OF THE INVENTION

Therefore, a goal of the present invention is to provide an electronic component-mounting device, and a method for preparing the same.

An aspect of the present invention is to provide a method for making an electronic component-mounting device, comprising providing an antenna on a polymeric device body by the steps of: forming on a surface of the polymeric device body a coating layer that includes a polymeric matrix and a plurality of conductive particles dispersed in the polymeric matrix, and depositing an electrically conductive layer on the coating layer opposite the polymeric device body.

### BRIEF DESCRIPTION OF THE DRAWINGS

Other features and advantages of the present invention will become apparent in the following detailed description of embodiments of this invention, with reference to the accompanying drawings, in which:

FIG. 1 is a flow chart of an embodiment of a method for making an electronic component-mounting device;

FIG. 2 is a cross sectional view showing the first embodiment of an electronic component-mounting device of the present invention;

FIG. 3 is a perspective view of the first embodiment shown in FIG. 2;

FIG. 4 is a fragmentary cross sectional view of the first embodiment shown in FIG. 2 taken along line IV-IV in FIG. 2;

FIG. 5 is a sectional view illustrating the second preferred embodiment of an electronic component-mounting device of the present invention, in which the polymeric device body has a U-shaped recess; and

FIG. 6 is a sectional view illustrating the third embodiment of an electronic component-mounting device of the present invention, in which an antenna is formed on an inner surface of a polymeric device body.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

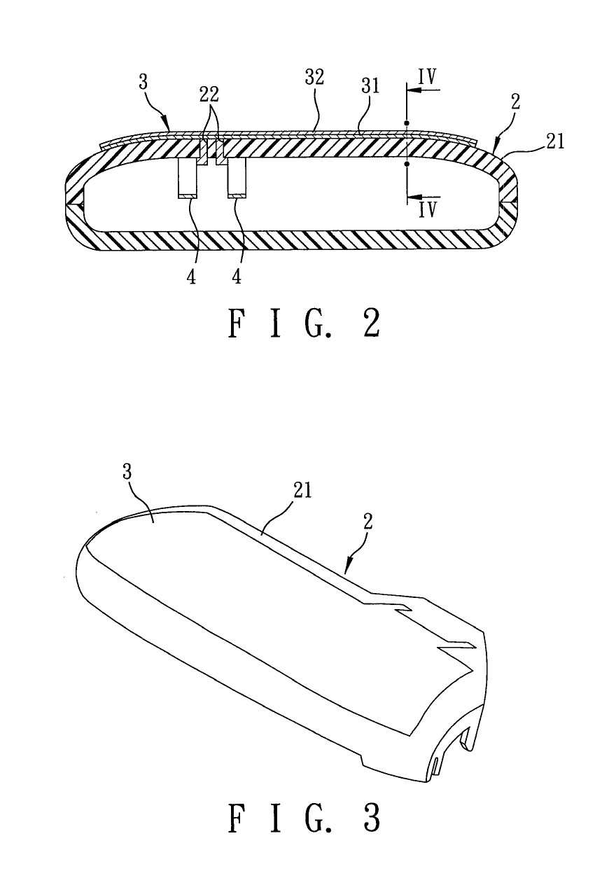

FIGS. 2 and 3 show the first embodiment of an electronic component-mounting device of this invention. The electronic component-mounting device can be used for mounting electronic components, e.g., batteries, integrated circuit boards, display panels, or a signal source. The electronic component-mounting device of this invention can be used in mobile electronic devices, such as smart phones, cell phones, notebooks, personal navigation devices, global positioning systems, tablet personal computers, etc. The typical operating RF frequency range is 200 Hz to 20 GHz.

As shown in FIGS. 2 and 3, the first embodiment of the electronic component-mounting device of this invention includes a polymeric device body 2, an antenna 3 and two antenna electrical contacts 4.

The polymeric device body 2 is made from polymeric materials, and may have a non-planar surface 21. In this embodiment, the non-planar surface 21 is smooth and curved. Alternatively, the non-planar surface 21 can be an angled surface, or a combination of curved and angled surfaces. For example, as shown in FIG. 5, the non-planar surface 31 is angled and defines a U-shaped recess. The surface can also have wavy, stair-like, concave or convex structure to meet requirements of different designs.

In the FIG. 2 embodiment, the antenna 3 is formed on an outer surface of the polymeric device body 2 and the antenna electrical contacts 4 are on an inner surface of the polymeric device body 2. The antenna 3 passes through through-holes 22 defined in the polymeric device body 2 to electrically connect to the antenna electrical contacts 4. Preferably, only a conductive layer 32 of the antenna 3 passes through the through holes 22 to electrically connect to the antenna electrical contacts 4. Alternatively, conventional pogo pins are disposed in the through holes 22 to electrically connect the antenna 3 to the antenna electrical contacts 4. Other electronic components that are to be mounted on the polymeric device body 2 may be electrically connected to the antenna 3 via the antenna electrical contacts 4.

In order to prevent moisture and dust from getting into the electronic component-mounting device, after electrically connecting the antenna 3 to the antenna electrical contacts 4, any remaining space in the through holes 22 can be sealed using an adhesive.

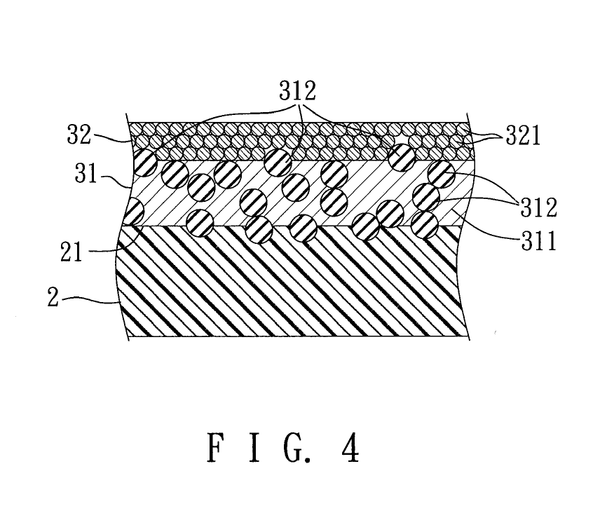

Referring to cross sectional view FIG. 4, the antenna 3 includes a coating layer 31 formed on the polymeric device body 2 and a conductive layer 32 formed on the coating layer 31 opposite the polymeric device body 2. The coating layer 31 is of materials that have similar properties to those of the polymeric device body 2 and the conductive layer 32. Specifically, the coating layer 31 includes a polymeric matrix 311 and conductive particles 312 dispersed in the polymeric matrix 311. Some of the conductive particles 312 as shown extend from the polymeric matrix 311. The presence of the polymeric matrix 311 and the conductive particles 312 in the coating layer 31 enables the coating layer 31 to provide strong interaction with the polymeric device body 2 and the conductive layer 32. Therefore, the coating layer 31 acts as a strong binder to ensure that the conductive layer 32 firmly adheres to the polymeric device body 2. An example of the coating layer 31 is a conductive varnish.

Specifically, the conductive varnish provides strong adhesion and is thermoresistant.

The coating layer 31 can be formed on the polymeric device body 2 by spray coating or printing, e.g., three-dimensional (3-D) printing. The conductive layer 32 can be formed using deposition methods, such as electroplating, electroless plating, sputtering, etc. Preferably, the polymeric matrix 311 is polycarbonate (PC), acyrlonitrile butadiene styrene (ABS) or a combination of PC and ABS.

FIG. 5 shows the second embodiment of an electronic component-mounting device of this invention. The difference between this embodiment and the first embodiment is that, in this embodiment, the non-planar surface is angled, and defines a U-shaped recess. Moreover, the antenna 3 is electrically connected to one antenna contact 4 by passing through one through hole 22.

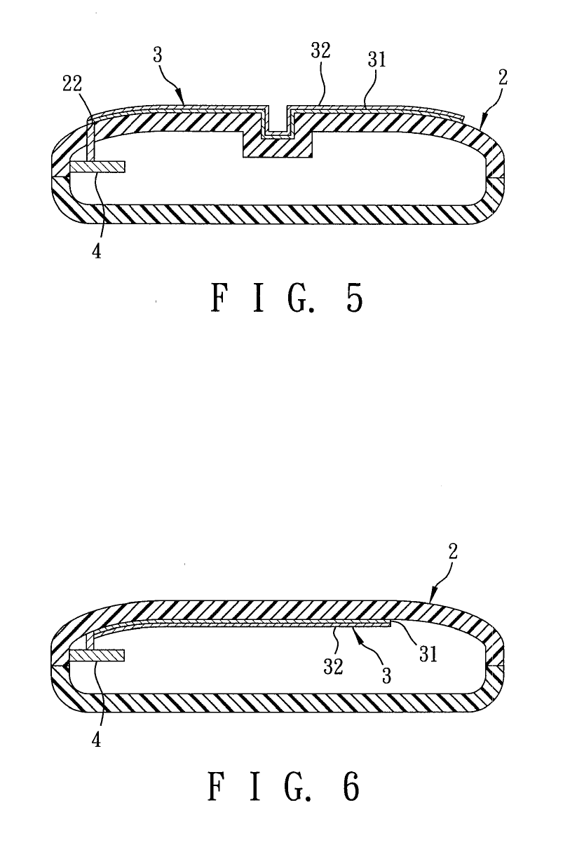

FIG. 6 shows the third embodiment of an electronic component-mounting device of this invention. In this embodiment, the antenna 3 is mounted on the inner surface of the polymeric device body 2, and thus, through hole is dispensed with.

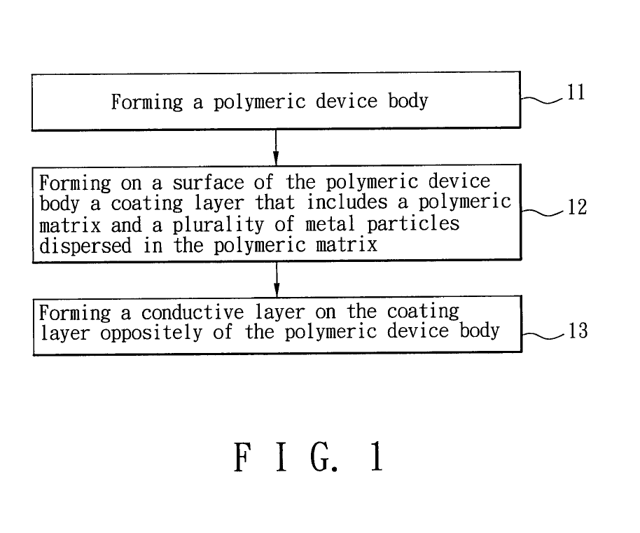

The present invention also provides a method for forming the aforesaid electronic component-mounting device. FIG. 1 illustrates the embodiment of a method for preparing an electronic component-mounting device of the present invention.

The first step 11 involves conventionally injection molding a polymeric material to form the polymeric device body 2.

Subsequently, in step 12, the coating layer 31 is formed on a surface of the polymeric device body 2. The coating layer 31 can be formed by using spray coating or printing, e.g., three-dimensional (3-D) printing. In a one embodiment of this invention, the coating layer 31 is formed by 3-D printing.

Lastly, in step 13, conductive particles are deposited onto the coating layer 31 by electroplating, electroless plating or sputtering to form the conductive layer 32, thereby forming the antenna 3 composed of the coating layer 31 and the conductive layer 32 on the polymeric device body 2.

To summarize, the present invention provides a method to form the antenna 3 on the polymeric device body 2 by spray coating the coating layer 31 and depositing the conductive layer 32. This overcomes the drawbacks of laser direct structuring, which includes complicated manufacturing procedures, limitation on substrate materials and expensive machinery. Moreover, the techniques used to form the coating layer 31 and the conductive layer 32 are not limited by surface configuration of the device body 2, and can be conducted on an electronic component-mounting device including a variety of shapes and sizes. In addition, the coating layer 31 of the antenna 3 of this invention is composed of two materials that have similar properties to the polymeric device body 2 and the conductive layer 32, respectively, thereby alleviating peeling problems occurred between the polymeric device body 2 and the conductive layer 32.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for making preparing an electronic component-mounting device, comprising:
forming on a surface of a polymeric device body a coating layer including a polymeric matrix and a plurality of conductive particles dispersed in the polymeric matrix; and
forming an electrically conductive layer defining an antenna on the coating layer opposite the polymeric device body.

2. The method as claimed in claim 1, wherein the coating layer is formed by spray coating or printing.

3. The method as claimed in claim 1, wherein the conductive layer is formed by deposition.

4. The method as claimed in claim 1, wherein the coating layer is formed by spray coating or printing, and the conductive layer is formed by deposition.

5. The method as claimed in claim 1, wherein the surface of the polymeric device body is non-planar.

6. The method as claimed in claim 1, the method further comprising forming an electrical contact on an inner surface of the polymeric device body, the polymeric device body defining a through hole, the surface where the antenna is provided being an outer surface opposite the inner surface, a portion of the antenna passing through the through hole to electrically connect to the electrical contact.

7. The method as claimed in claim 6, the method further comprising sealing a space between the polymeric device body and the antenna in the through hole with adhesive.

8. The method as claimed in claim 1, wherein the polymeric device body has an inner and an outer surface, and the coating layer and electrically conductive layer are formed on the inner surface.
